(19) United States
(12) Patent Application Publication
(10) Pub. No.: US 2024/0235987 A9
(43) Pub. Date: Jul. 11, 2024

(54) COMMUNICATION SYSTEM, COMMUNICATION METHOD, COMMUNICATION DEVICE, AND PROGRAM

(71) Applicant: NIPPON TELEGRAPH AND TELEPHONE CORPORATION, Tokyo (JP)

(72) Inventors: Tomohiko IKEDA, Musashino-shi, Tokyo (JP); Satoshi NARIKAWA, Musashino-shi, Tokyo (JP); Takuya ABE, Musashino-shi, Tokyo (JP)

(73) Assignee: NIPPON TELEGRAPH AND TELEPHONE CORPORATION, Tokyo (JP)

(21) Appl. No.: 18/271,501

(22) PCT Filed: Jan. 20, 2021
(86) PCT No.: PCT/JP2021/001780

§ 371 Date: Jul. 10, 2023

(51) Int. Cl. H04L 45/24; H04L 69/14; H04L 69/164

(52) U.S. Cl. CPC H04L 45/24; H04L 69/14; H04L 69/164

(57) ABSTRACT

An object of the present disclosure is to make multipath technology applicable to UDP.

The present disclosure is a communication system in which a plurality of communication devices are connected via a plurality of networks, wherein one of the plurality of communication devices reads application data stored in a UDP payload, and stores information on a multipath option as a part of the application data, and the other one of the plurality of communication devices reads application data stored in a UDP payload, acquires information on a multipath option from the application data, and executes communication via the plurality of networks on the basis of the acquired information on the multipath option.

### TECHNICAL FIELD

The present invention relates to seamless switching of UDP multipaths in a network.

### BACKGROUND ART

In the conventional MPTCP (MultiPath Transmission Control Protocol), a common MPTCP socket of L4 is presented to an application as the same socket, by bundling the IP (Internet Protocol) addresses and TCP (Transmission control Protocol) sessions (multipaths) of a plurality of interfaces. Thus, even if one of the multipaths is disconnected due to a failure or the like and an IP address and a TCP session are changed, the common MPTCP socket can be made appear to the application side as if there is no change, which enables avoidance of session interruption and seamless path switching. However, the MPTCP can be applied only to TCP and cannot be applied to UDP (User Datagram Protocol).

### CITATION LIST

### Non Patent Literature

[NPL 1] RFC8684-TCP Extensions for Multipath Operation with

### Multiple Addresses

### SUMMARY OF INVENTION

### Technical Problem

An object of the present disclosure is to make multipath technology applicable to UDP.

### Solution to Problem

In the present invention, session establishment and packet rearrangement are carried out by storing a multipath option in a payload portion of the UDP and reading the multipath option. A communication system according to the present disclosure is a communication system in which a plurality of communication devices are connected via a plurality of networks, wherein one of the plurality of communication devices
reads application data stored in a UDP payload, and stores information on a multipath option as a part of the application data, and
the other one of the plurality of communication devices reads application data stored in a UDP payload, acquires information on a multipath option from the application data, and
executes communication via the plurality of networks on the basis of the acquired information on the multipath option.

A communication method according to the present disclosure is a method executed by a communication system connected via a plurality of networks, wherein
one of the plurality of communication devices reads application data stored in a UDP payload, and stores information on a multipath option as a part of the application data, and
the other one of the plurality of communication devices reads application data stored in a UDP payload, acquires information on a multipath option from the application data, and
executes communication via the plurality of networks on the basis of the acquired information on the multipath option.

In a communication device according to the present disclosure a plurality of interfaces are connected to different networks, when any of the plurality of interfaces transmits a UDP packet,
application data stored in a UDP payload of the UDP packet is read, and
information on a multipath option is stored as part of the application data.

In a communication device according to the present disclosure a plurality of interfaces are connected to different networks, when any of the plurality of interfaces receives a UDP packet, application data stored in a UDP payload of the UDP packet is read,
information on a multipath option is acquired from the application data, and
communication via the different networks is executed on the basis of the acquired information on the multipath option.

Specifically, a program of the present disclosure is a program for realizing a computer as each functional unit provided in a communication device according to the present disclosure and a program for causing a computer to execute each step provided in a communication method performed by the communication device according to the present disclosure.

### Advantageous Effects of Invention

The present disclosure can make multipath technology applicable to UDP. Therefore, the present disclosure can seamlessly switch paths even in the event of failures, thus enabling stable communication and service provision.

### BRIEF DESCRIPTION OF DRAWINGS

FIG. 1 shows an example of a system configuration of the present disclosure.

FIG. 2 shows an example of a layer structure of the present disclosure.

FIG. 3 shows an example of a multipath option in the present disclosure.

FIG. 4 shows an example of the multipath option in the present disclosure.

FIG. 5 shows examples of configurations of a user terminal and a service server.

FIG. 6 shows an example of a path establishment sequence.

FIG. 7 shows an example of a sequence number.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

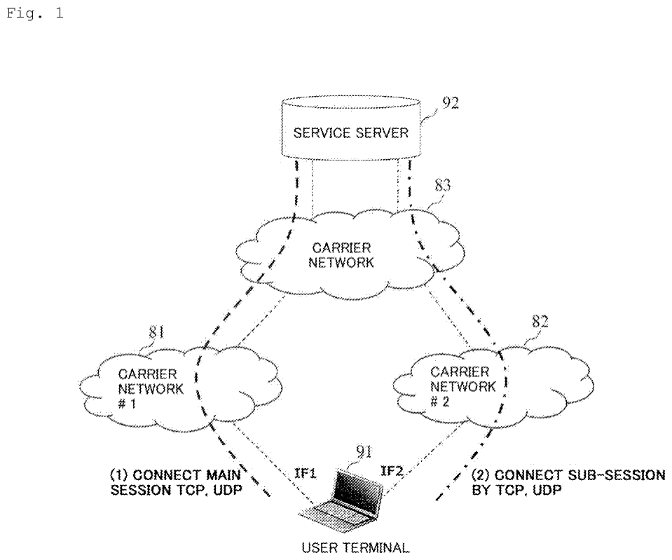

FIG. 1 shows an example of a system configuration of the present disclosure. In a communication system of the present disclosure, a user terminal 91 and a service server 92 of the Internet are connected by a plurality of networks. For example, the user terminal 91 is connected to carrier networks 81 and 82, and the carrier networks 81 and 82 are connected to the service server 92 via a carrier network 83. The user terminal 91 and the service server 92 can establish a main session and a sub-session by TCP. In addition, in the present disclosure, the user terminal 91 and the service server 92 function as a communication device of the present disclosure, and can establish a main session and a sub-session by UDP.

### (Key Points for Realization)

Conventional MPTCP technology uses an option area in a TCP header to establish a multipath, and thereafter uses a packet scheduler to compare RTTs (Round-Trip Time) of respective interfaces and determine a priority transmission order for each interface (hereinafter referred to as “IF”). Based on this determination, a sequence number is placed in the TCP option area, and a packet is transmitted. The reception side receives the packet, aligns the sequence number order, and receives the packet In this processing, the packet scheduler is realized using an MPTCP compatible kernel. Multipath establishment and sequence number placement/integration are realized using the TCP option.

Functions previously realized by MPTCP using TCP, such as:
(1) establishment of multipaths, and
(2) sequence number placement/alignment, are realized using a UDP payload area in UDP.

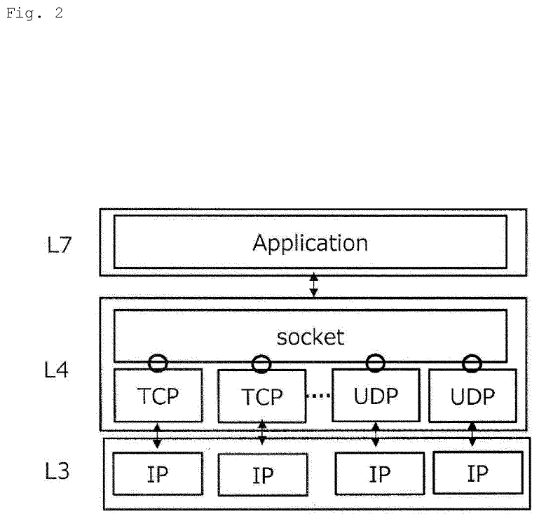

FIG. 2 shows an example of a layer configuration of the present disclosure. The present disclosure realizes data transmission and reception by storing data stored in the TCP option area in the UDP payload. Thus, the present disclosure bundles multipaths into a common socket of L4, and shows them as the same socket to an application.

Since there is no space in the option area of the UDP header, the multipath option cannot be stored in this area. In addition, the multipath option cannot be mounted on the payload area without an API (Application Programming Interface) library. Therefore, an API library is mounted on the transmission and reception sides, and a multipath option by UDP is realized.

Seamless handover can be realized even in UDP without depending on a TCP protocol by realizing the multipath techniques (1) and (2). As a result, the multipath technology can be applied to many application services, seamless path switching can be performed even at the time of handover, and stable communication can be performed.

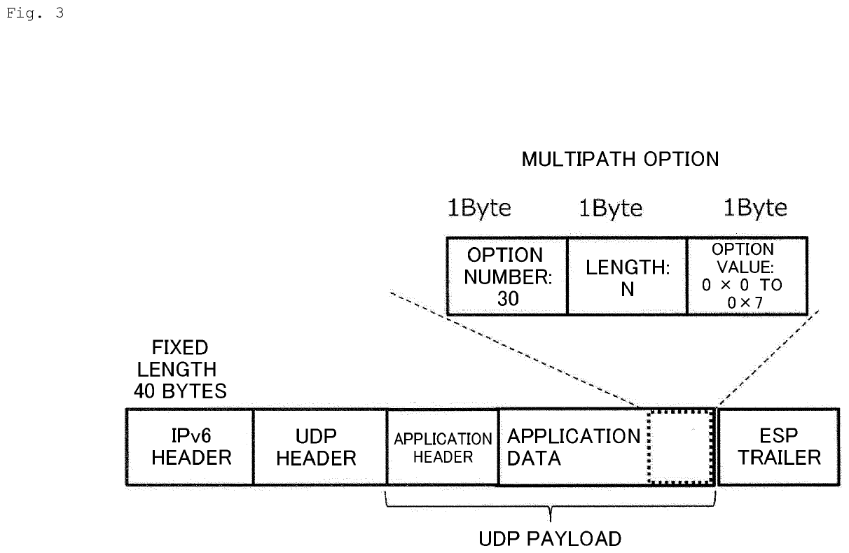

FIG. 3 shows an example of a UDP packet structure of the present embodiment. A multipath option is stored in an application data part of the UDP payload. For UDP, session establishment and packet rearrangement are performed by reading the end of application data. Therefore, the communication device of the present disclosure includes an API library corresponding to various application protocols, a reading unit, and a writing unit.

The multipath option includes an option number storage area (1 Byte), a length N storage area (1 Byte), and an option value storage area (1 Byte).

An option number 30 is stored in the option number storage area. This number is a unique number assigned to the MPTCP, and is defined by, for example, IRNA (Internet Assigned Numbers Authority).

The definition of the data length at the time of data addition when data is added in addition to an option is stored in the length N storage area. For example, when a sequence number is added, the length of the sequence number is stored.

For example, the following items are stored in the option value storage area.
0×0: Confirmation of multipath mounting
0×1: Confirmation of sub-flow
0×2: Confirmation of sequence number
0×3: Addition of address
0×4: Deletion of address
0×5: Multipath priority
0×6: Fallback
0×7: Close

The sequence number is stored following the option value.

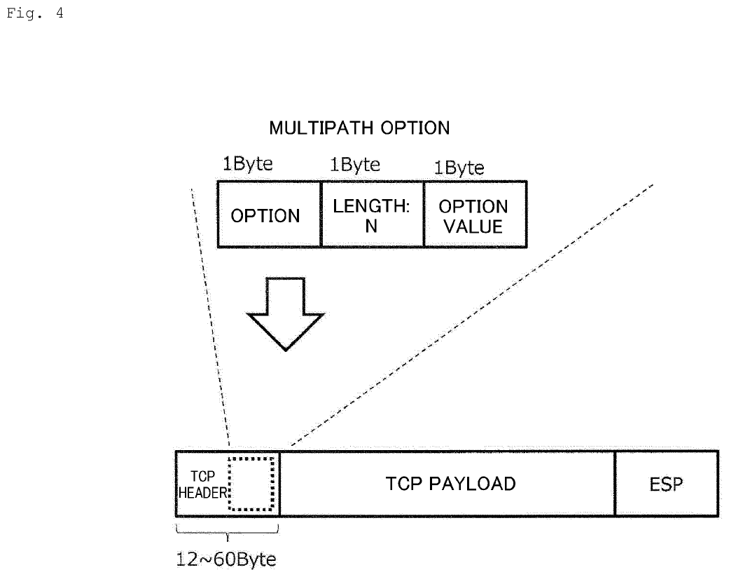

FIG. 4 shows an example of a TCP packet structure of the present embodiment. The multipath option may be stored in a TCP header in the TCP packet. For example, a 12- to 60-Byte TCP header includes the option number storage area (1 Byte), the length N storage area (1 Byte), and the option value storage area (1 Byte).

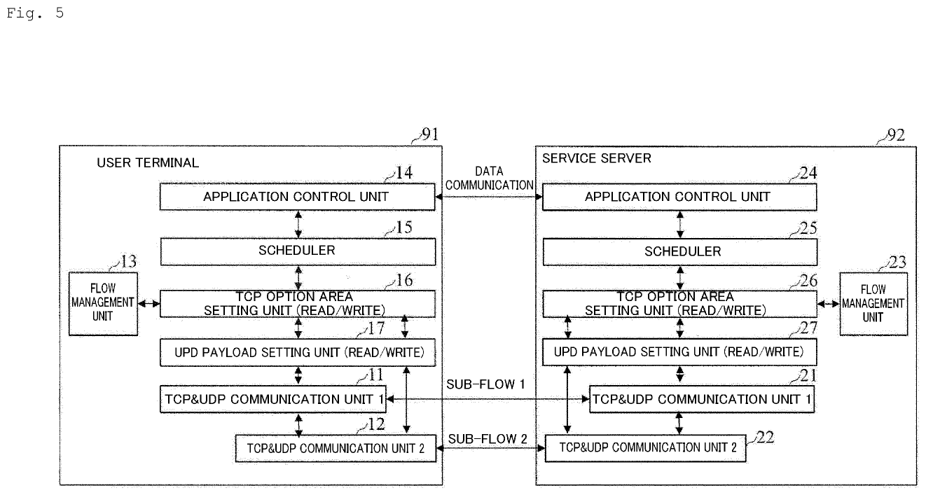

FIG. 5 is a configuration diagram showing the user terminal 91 and the service server 92 according to the present embodiment. The user terminal 91 includes a TCP&UDP communication unit 11, a TCP&UDP communication unit 12, a flow management unit 13, an application control unit 14, a scheduler 15, a TCP option area setting unit 16, and a UDP payload setting unit 17. The service server 92 includes a TCP&UDP communication unit 21, a TCP&UDP communication unit 22, a flow management unit 23, an application control unit 24, a scheduler 25, a TCP option area setting unit 26, and a UDP payload setting unit 27. The communication device of the present disclosure, that is, the service server 92 and the user terminal 91 can also be realized by a computer and a program, and the program can be recorded on a recording medium or provided over a network.

The TCP&UDP communication units 11, 12, 21, and 22 perform TCP communication or UDP communication for each interface. For example, the TCP&UDP communication units 11 and 21 establish connection by using UDP, and the TCP&UDP communication units 12 and 22 establish connection by using UDP. The TCP&UDP communication units 11 and 21 may establish connection by using TCP, and the TCP&UDP communication units 12 and 22 may establish connection by using UDP.

The flow management units 13 and 23 manage a main flow and a sub-flow. After confirming a correspondence between the terminal 91 and the service server 92 in the main flow, construction of a sub-flow is started. The main flow and the sub-flow are associated with each other. For example, if the priority of the TCP&UDP communication units 11 and 21 is higher than that of the TCP&UDP communication units 12 and 22, the communication of the TCP&UDP communication units 11 and 21 is treated as the main flow and the communication of the TCP&UDP communication units 12 and 22 is treated as the sub-flow.

The schedulers 15 and 25 separate and reintegrate data. On the transmission side, the schedulers 15 and 25 determine a priority order for each interface and determine a transmission interface of each packet. A packet sequence number is determined accordingly, and instructions are provided to the TCP option area setting units 16 and 26 and the UDP payload setting units 17 and 27.

On the reception side, the schedulers 15 and 25 reintegrate the data received by the TCP&UDP communication unit on the basis of sequence numbers read by the TCP option area setting units 16 and 26 and the UDP payload setting units 17 and 27.

The TCP option area setting units 16 and 26 write and read to and from the TCP option area.

On the transmission side, the TCP option area setting units 16 and 26 store each option in the TCP option area on the basis of the instructions of the schedulers 15 and 25 and the flow management units 13 and 23.

On the reception side, the TCP option area setting units 16 and 26 transmit information read from the TCP option area to the flow management units 13 and 23. Other than that, the data is transmitted to the schedulers 15 and 25.

The UDP payload setting units 17 and 27 have API libraries corresponding to various applications, and read and write UDP payloads accordingly.

On the transmission side, the UDP payload setting units 17 and 27 store multipath options as a part of application data of the UDP payloads on the basis of instructions from the schedulers 15 and 25 and the flow management units 13 and 23. On the reception side, the UDP payload setting units 17 and 27 transmit information read from the multipath options to the flow management units 13 and 23. Other than that, the information is transmitted to the schedulers 15 and 25.

In this manner, in the present embodiment, multipaths are realized by the UDP payload setting units 17 and 27 for UDP and the TCP option area setting units 16 and 26 for TCP, respectively.

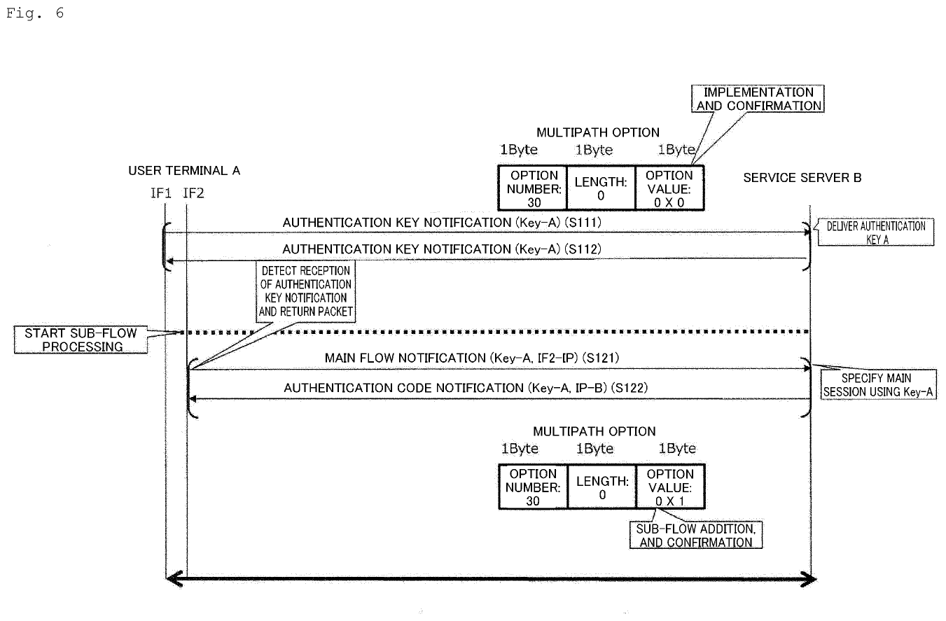

FIG. 6 shows an example of a path establishment sequence executed by the flow management units 13 and 23. After the exchange of notifying a user terminal A of an authentication key (Key-A) in an IF 1 (S111 and S112), the user terminal A starts sub-flow processing in an IF 2. In so doing, when transmission and reception are performed by using UDP communication, the sub-flow processing is started by storing the authentication key (Key-A) in a UDP payload (S121) and having the reception side read the authentication key (S122).

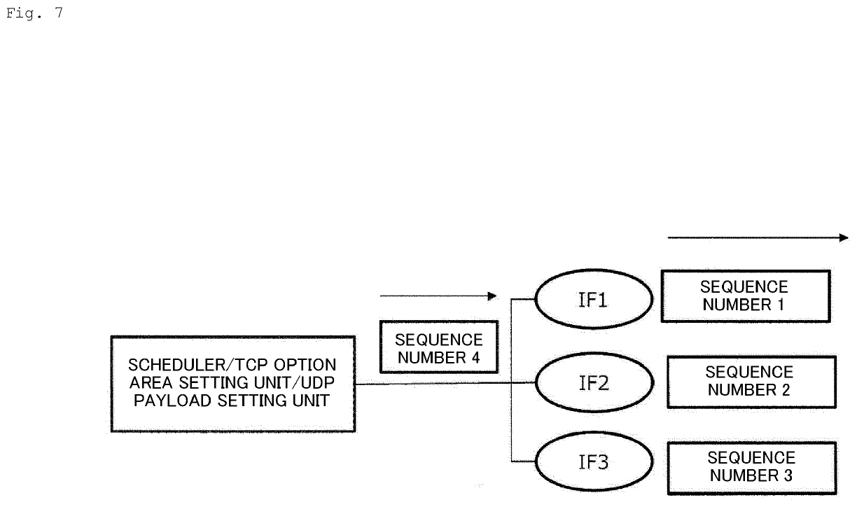

FIG. 7 shows an example of a sequence number. In the case of transmission by using UDP communication, the UDP payload setting units 17 and 27 read application data stored in the UDP payload and store a sequence number as a part of the application data. The sequence number is a sequence number unified between multipaths, and the reception side can integrate the packets between the multipaths by confirming the sequence number.

When receiving the application data by using UDP communication, the UDP payload setting units 17 and 27 read the application data stored in the UDP payload, and acquire the sequence number unified between the multipaths from the application data. Then, the schedulers 15 and 25 rearrange the packets on the basis of the sequence number acquired by using TCP communication and UDP communication.

In the case of transmission using TCP communication, the TCP option area setting units 16 and 26 store the sequence number in the TCP option area. In the case of reception by using TCP communication, the TCP option area setting units 16, 26 acquire the sequence number unified between the multipaths from the TCP option area.

Thus, in the present embodiment, both the carrier networks 81 and 82 can be bundled and shown as the same socket to the application. In the present disclosure, packets transmitted and received via the networks 81 and 82 may be only UDP packets or both TCP packets and UDP packets.

### (Audio and Video Traffic)

By this technique, video and audio services used by UDP can be used in a multipath. Thus, since a plurality of sessions can be bundled by one MPTCP socket, IP address variations can be absorbed in switching in heterogeneous networks. Therefore, seamless switching can be performed.

Also, the multipath connection allows the system to function as a redundant system because even if one path is interrupted, the other path is still communicating. For example, if a certain amount of packet loss occurs and the quality of one network is degraded, the network of one of the multipaths may disconnect.

### INDUSTRIAL APPLICABILITY

The present disclosure is applicable to information and communication industries.

### REFERENCE SIGNS LIST

11, 12, 21, 22: TCP&UDP communication unit
13, 23: Flow management unit
14, 24: Application control unit
15, 25: Scheduler
16, 26: TCP option area setting unit
17, 27: UDP payload setting unit
81, 82, 83: Carrier network
91: User terminal
92: Service server

1. A communication system in which a plurality of communication devices are connected via a plurality of networks, wherein
one of the plurality of communication devices
reads application data stored in a UDP payload, and
stores information on a multipath option as a part of the application data, and
the other one of the plurality of communication devices
reads application data stored in a UDP payload,
acquires information on a multipath option from the application data, and
communication via the plurality of networks is executed on the basis of the acquired information on the multipath option.

2. The communication system according to claim 1,
wherein the information on the multipath option includes a sequence number unified in the plurality of networks, and
the other one of the plurality of communication devices rearranges data received via the plurality of networks based on a sequence number stored as a part of the application data stored in the UDP payload.

3. A communication method is a method executed by a communication system connected via a plurality of networks, wherein
one of the plurality of communication devices
reads application data stored in a UDP payload, and
stores information on a multipath option as a part of the application data, and
the other one of the plurality of communication devices
reads application data stored in a UDP payload,
acquires information on a multipath option from the application data, and
executes communication via the plurality of networks on the basis of the acquired information on the multipath option.

4. A communication device, wherein a plurality of interfaces are connected to different networks,
when any of the plurality of interfaces transmits a UDP packet,
application data stored in a UDP payload of the UDP packet is read, and
information on a multipath option is stored as part of the application data.

5. (canceled)

6. A non-transitory computer-readable medium having computer-executable instructions that, upon execution of the instructions by a processor of a computer, cause the computer to function as the communication device according to claim 4.
